(19) United States
(12) Patent Application Publication
(10) Pub. No.: US 2011/0022443 A1
(43) Pub. Date: Jan. 27, 2011

(54) EMPLOYMENT INFERENCE FROM MOBILE DEVICE DATA

(75) Inventors: Kurt E. Partridge, Palo Alto, CA (US); Philippe J. P. Golle, San Francisco, CA (US); Maurice K. Chu, Burlingame, CA (US)

Correspondence Address: PVF -- PARC;c/o PARK, VAUGHAN & FLEMING LLP, 2820 FIFTH STREET, DAVIS, CA, 95618-7759, US

(73) Assignee: PALO ALTO RESEARCH CENTER INCORPORATED, Palo Alto, CA (US)

(21) Appl. No.: 12/506,863

(22) Filed: Jul. 21, 2009

(51) Int. Cl. G06Q 10/00; G01C 21/00; G06Q 50/00

(52) U.S. Cl. 705/10; 701/300

(57) ABSTRACT

One embodiment of the present invention provides a system for inferring a user's activity. During operation, the system collects contextual information recorded by a plurality of components located on a mobile device associated with the user. The system then extracts the user's behavior pattern based on the collected contextual information, and determines whether the user is engaged in an employment-related activity.

### BACKGROUND

1. Field

This disclosure is generally related to inference of a user's activity. More specifically, this disclosure is related to using data collected by mobile devices to infer a user's activity related to employment.

2. Related Art

Many technology observers forecast that location-based services will revolutionize how we live our everyday lives. However, most would acknowledge that although location provides a strong hint as to a user's activities and goals, it does not completely determine them. For example, a location-based advertising system would under-perform if it delivers coffee coupons to employees of a coffee shop. Hence, location is only a substitute for a much more important piece of information: activity. Activity indicates what a user is doing at any given time, and can give greater insight into the user's goals, needs, and desires. Activity inference is a sub-problem common to many applications in areas such as health monitoring, information delivery, and transportation prediction. It also shows promise for many more applications that benefit from accurate user models, such as helping people understand how they spend their time, providing ethnographers with more data to help them better understand human behaviors, and supplying epidemiologists with information that helps them understand the relationship between behavior and health.

The proliferation of mobile devices and their increasing computational capacity have made it possible to track the daily activities of users of such devices. Many mobile applications rely on the detection of a user's location to infer the user's activity. For example, if the user is detected to be in a restaurant, then most likely he is eating. Similarly, if the user is detected to be in a movie theater, then most likely he is watching a movie. However, such location-based activity inference has been proven to be less than ideal. A recent study of national time-use data has shown that location and time together can predict activity 60-70% of the time, whereas the reminder of the time, activities are not well predicted by such a combination.

In order to infer activity accurately, a typical approach relies on installation of sensors. For example, to infer in-home activity, a typical approach is to outfit a home with sensors such as cameras, microphones, infrared sensors, RFID readers, and contact sensors, and to collect sensor data to infer activity. The relationship between sensor data and activity can be encoded by predetermined rules, or by machine learning. However, such an approach relies on the installation of infrastructure; thus, it does not scale well to locations that are not covered by infrastructure, particularly if the goal is to sense all activities that a person is performing throughout a day. In addition, it also requires significant cost and maintenance to support the infrastructure where it is installed.

### SUMMARY

One embodiment of the present invention provides a system for inferring a user's activity. During operation, the system collects contextual information recorded by one or more components located on a mobile device associated with the user. The system then extracts the user's behavior pattern based on the collected contextual information, and determines whether the user is engaged in an employment-related activity based at least on the user's behavior pattern.

In a variation on this embodiment, the system compares the user's behavior pattern with known user behavior patterns. The system can also receive the user's input of information associated with his employment. In addition, the system can obtain census data associate with employment.

In a variation on this embodiment, extracting the user behavior pattern involves extracting information associated with a location the user has visited and extracting timing information associated with the user corresponding to the location.

In a further variation on this embodiment, the timing information includes one or more of: duration of the visit, time of the day and/or time of the week of the visit, repeat pattern of the visit, and beginning and/or ending time of the visit.

In a further variation, the location information comprises at least one of: a venue type, whether the location is a known location associated with the user's employment, and distance from the location to the user's home.

In a variation on this embodiment, the components include at least one of: a GPS receiver, a WiFi receiver, a Bluetooth® transceiver, an accelerometer, a clock, a microphone, a light sensor, and a calendar.

In a further variation, the system performs one or more of the following operations: extracting ambient sound information detected by the microphone, extracting ambient light information detected by the light sensor, extracting accelerometer traces, extracting information regarding the setting of the mobile device, and detecting presence of a second mobile device.

### BRIEF DESCRIPTION OF THE FIGURES

FIG. 1 presents a diagram illustrating a user carrying one or more mobile devices.

FIG. 2 presents a block diagram illustrating an exemplary architecture of an employment-inference system in accordance with an embodiment of the present invention.

FIG. 3 presents a diagram illustrating exemplary daily activities of a user that can be inferred in accordance with an embodiment of the present invention.

FIG. 4 presents a flowchart illustrating the process of determining employment-related activity in accordance with an embodiment of the present invention.

FIG. 5 illustrates an exemplary computer system for inferring employment-related activity in accordance with one embodiment of the present invention.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention provide a system for inferring whether a user's activity is employment related. The system uses data collected by a number of sensor components located on a mobile device associated with the user to extract the user's behavior pattern. Based on the user's behavior pattern, the system then determines whether the user is engaged in an employment-related activity.

### Inferring Employment-Related Activity

Although a strong hint, location can be inaccurate in predicting an activity. Time-use studies based on diary data suggest that a major confounder in predicting activity is employment. For example, being in a restaurant does not always indicate that a person is eating; instead, the person can be an employee working in the restaurant. Actually, it is more likely for a person between 18 and 24 years old to work than to eat in a restaurant.

Depending on a person's role in a particular location, such as a customer or an employee, his activity at the location is likely to be different. Thus, a location-based service that cannot distinguish between a customer and an employee of a certain location would provide less than ideal services. For example, a location-based advertising system would underperform if it delivers coffee coupons to employees of coffee shops.

To obtain information regarding a user's employment, one direct approach is to query the user. However, such an approach has several drawbacks. First, the user might not notify the system when he changes jobs. According to the Bureau of Labor and Statistics, job turnover rates can range from 1-2% per month in government and education to 6% per month in accommodation and food services. A user may change jobs frequently and find it cumbersome to notify the system of every job change. Furthermore, when a user is queried about his job, the job code category may be either too coarse to provide useful information, or too fine for the user to correctly identify his job. Therefore, automatic employment inference is useful and important.

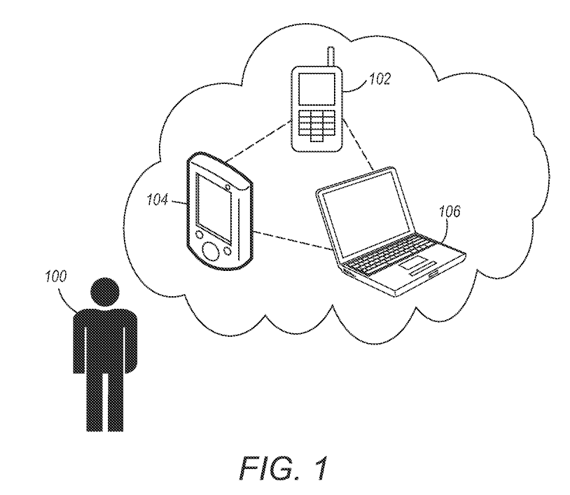

Embodiments of the present invention provide a system that uses data collected by sensor components of a mobile device associated with a user to infer the user's employment. FIG. 1 presents a diagram illustrating a user 100 carrying one or more mobile devices, including but not limited to: a mobile phone 102, a personal digital assistant (PDA) 104, and a laptop computer 106. Each mobile device is equipped with a number of sensors that can be used to collect contextual information.

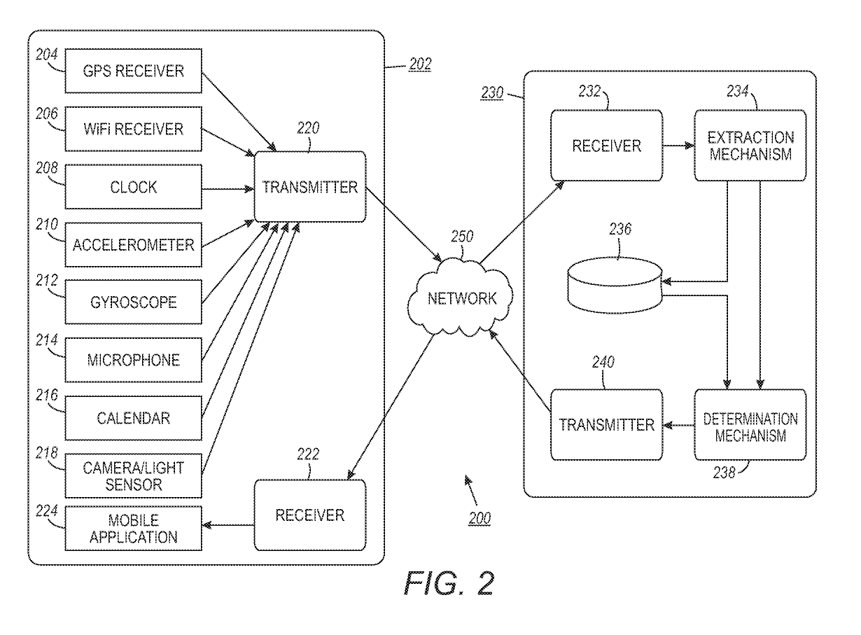

FIG. 2 presents a block diagram illustrating an exemplary architecture of an employment-inference system in accordance with an embodiment of the present invention. Employment-inference system 200 includes a mobile computing device 202, a remote server 230, and a network 250. In one embodiment, mobile computing device 202 collects contextual data associated with a user and transmits this data to remote server 230 over network 250. Remote server 230 then analyzes the received contextual data and compares it with a user behavior pattern. Based on the comparison, remote server 230 can determine whether the user is engaged in employment-related activities.

Remote server 230 includes a receiver 232, an extraction mechanism 234, a database 236, a determination mechanism 238, and a transmitter 240. In one embodiment, receiver 232 receives contextual sensor data from mobile computing device 202 and sends such data to extraction mechanism 234. Extraction mechanism 234 extracts information regarding the user's behavior pattern and the surroundings, and maps such information to known employment-related user behavior patterns stored in database 236. Determination mechanism 238 determines whether the user is engaged in an employment-related activity based on the extracted information and the mapping result, and sends the result to transmitter 240, which in turn transmits such information back to mobile device 202 via network 250. Receiver 222 on mobile device 202 receives the inference of the user's employment and feeds such information to mobile application 224. Mobile application 224 can be a location-based application, such as people finder. In one embodiment, information regarding the user's employment is sent to other location-based applications running at remote server 230, such as a location-based advertisement service.

In some embodiments, the functionalities of remote server 230 can be included in mobile device 202, which obviates the need of communication across network 250.

Mobile computing device 202 can be any portable device with computational capability. Examples of mobile computing device 202 include, but are not limited to: a mobile phone, a PDA, and a laptop computer. Network 250 may correspond to any type of wired or wireless communication channels capable of coupling together computing nodes (e.g., mobile computing device 202 and remote server 230). This includes, but is not limited to, a local area network (LAN), a wide area network (WAN), and/or a combination of networks, and phone and cellular phone networks, such as Global System for Mobile communications (GSM) networks and 3G (third generation) wireless networks. Remote server 230 may correspond to a node on the network that can provide a service to mobile device 202. For example, remote server 230 can provide an employment-inference service to mobile device 202.

Mobile device 202 includes a number of sensors, such as a GPS receiver 204, a WiFi receiver 206, a clock 208, an accelerometer 210, a gyroscope 212, a microphone 214, a calendar 216, and a camera/light sensor 218. Mobile device 202 can also include a transmitter 220, a receiver 222, and a mobile application 224. GPS receiver 204 and WiFi receiver 206 can provide information regarding the user's location. Clock 208 can provide timing information such as the local time of day. Accelerometer 210 and/or gyroscope 212 can provide information regarding the user's motion if mobile device 202 is located in the user's clothing. Microphone 214 can sense ambient noise that can be used to determine employment. Calendar 216 can provide information regarding the day of week and the user's appointments. Camera/light sensor 218 can provide information regarding the lighting of the surroundings or can automatically take a picture of the surroundings. Transmitter 220 can transmit data collected by various sensors to remote server 230 via network 250.

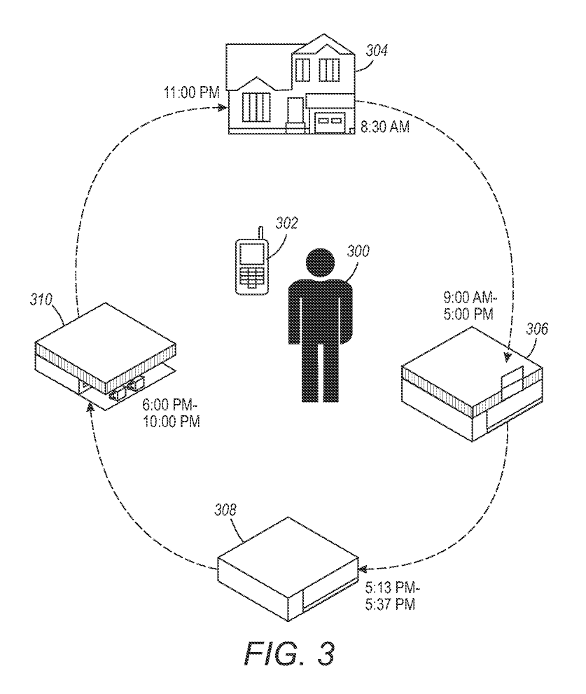

FIG. 3 presents an exemplary diagram illustrating a user's daily activities that can be inferred in accordance with an embodiment of the present invention. In FIG. 3, a user 300 is carrying a mobile phone 302 which includes a number of sensing components, such as a GPS receiver and a clock. On a typical day, based on information provided by the GPS receiver and the clock, the system can determine that user 300 leaves his home 304 at 8:30 AM. Note that user 300 can report the location of his home to the system, or the system can determine the location of user 300's home by collecting and analyzing sensor data. At 9:00 AM, GPS data indicates that user 300 arrives at grocery store 306, and at 5:00 PM, GPS data indicates that user 300 leaves grocery store 306. GPS data and clock output also indicate that user 300 stops at a fast food restaurant 308 between 5:13 PM and 5:37 PM, stays in a gas station 310 between 6:00 PM and 10:00 PM, and returns home 304 at 11:00 PM. Using contextual information collected by user 300's mobile device, an employment-inference system can determine whether an activity of user 300 is employment related.

In this example, user 300 may be a customer or an employee of grocery store 306, fast food restaurant 308, or gas station 310. In order to determine the role of user 300 in grocery store 306, the system obtains the length of time user 300 spent in grocery store 306. Such information can be obtained by combining the GPS data and the clock output. Note that although shift lengths may vary, an employee of a retail establishment tends to stay longer than a typical customer. For example, an eight- or six-hour stay is much more likely to be a work shift than a shopping trip. In the example shown in FIG. 3, based on the GPS signal and the clock output, the system determines that the length of time user 300 spends in grocery store 306 is between 9:00 AM and 5:00 PM, which is eight hours long. Such a long stay indicates that most likely user 300 is an employee working in grocery store 306. Similarly, the system can determine that the length of time spent by user 300 in gas station 310 is four hours, which is significantly longer than a typical customer, who often spends less than ten minutes in a gas station. Thus, user 300 is more likely to be working in gas station 310. On the other hand, user 300 spends around twenty minutes in fast food restaurant 308, demonstrating a typical customer behavior.

For people with fixed jobs (jobs that are performed at specific locations) or semi-fixed jobs (jobs that are performed in specific locations on a temporary basis), the long duration of their stay at particular locations often suggests employment-related activities. Examples of fixed jobs include, but are not limited to: office work, factory labor, and teaching. Examples of people with semi-fixed jobs include, but are not limited to: construction workers, general contractors, and real-estate agents. For people with mobile jobs (jobs that involve movement from place to place), short stays at successive locations may suggest employment-related activities. Note that people with mobile jobs may have regular routes during a regular time period (such as bus drivers), irregular routes during a regular time period (such as pizza delivery employees), or irregular routes at irregular times (such as taxi drivers).

In addition to using the duration of stay at a location, in one embodiment, the system can also use the time of day at a location to determine whether a user is engaged in employment-related activities in the location. For example, office workers, such as government employees, often work a typical shift between 8 AM and 5 PM. On the other hand, a bakery worker is more likely to work a much earlier shift, such as a shift between 6 AM and 3 PM. For retail jobs, presence at the site before or after the site is open to its customers often suggests an employment-related activity. In FIG. 3, user 300 arrives at grocery store 306 at 9 AM. Because grocery store 306 does not open its door to its customers until 10 AM every day, the system can determine that user 300 enters grocery store 306 for employment purposes. In addition to predicting fixed or semi-fixed jobs, the system can also extract a user behavior from the time of day at locations and predict activities related to mobile jobs.

For example, a bus driver often visits the same place at the same time of day; a postal delivery agent, although not at the same place at exactly the same time, is likely to visit the same places in the same order. A delivery driver may skip stopping places from his daily delivery route; however, the route is followed at roughly the same time every day. A courier may not follow a particular route each day, but his movement pattern when he is working is likely to be different compared with the one when he is not working. Besides time of day, the system can also use day of week (extracted from the calendar of the mobile device) to infer employment. For example, moviegoers or amusement park visitors tend to visit theaters or parks during weekends while employees of such places need to be there during the week.

Other timing information that can be used to infer employment includes time boundaries at a particular location. In one embodiment, a time boundary, which includes the exact time that a person arrives and leaves a location, can also be used to infer employment. Because certain jobs may run on a fixed schedule, such as factory jobs, a rigid time boundary, such as hourly or half-hourly boundaries, at a location can suggest employment-related activities. For example, in FIG. 3, user 300 arrives at grocery store 306 at around 9 AM and leaves at around 5 PM, demonstrating an hourly time boundary. Compared with a customer who may arrive and leave a store at random times during an hour, the system can determine that user 300 is more likely to be an employee at store 306 working a nine-to-five work shift. Similarly, user 300's stay at gas station 310 is also marked by hourly boundaries (between 6 and 10 PM), thus suggesting employment-related activity. In contrast, the beginning and ending times of user 300's stay at fast food restaurant 308 are not on the hour or half hour, thus suggesting customer behavior. Note that the system can use an accuracy figure, such as the dilution of precision (DOP) value including the HDOP (horizontal-DOP) value and the VDOP (vertical-DOP) value, of the GPS receiver to determine an exact time user 300 enters or leaves grocery store 306. Such determination is based on the fact that GPS signals are often weakened indoors, leading to increased positioning errors.

In one embodiment, once it is determined that user 300 is an employee of grocery store 306 or gas station 310, the system may infer any future activities of user 300 conducted in grocery store 306 or gas station 310 as employment related, even if such activity does not match a usual time of day or duration for known employment-related activity of user 300. For example, on certain days, user 300 may work a different shift, such as a shift between noon and 5 PM, at grocery store 306. Although such a behavior pattern does not fit previously extracted behavior patterns of user 300, the system can still determine that user 300 is engaged in an employment-related activity because the system knows that user 300 is an employee of store 306.

In one embodiment, the system can also infer employment based on whether a user pays regular and repeated visits to a certain location. People working on fixed jobs often repeat their visit to the same place over a long period of time. For example, office workers may visit their office every weekday over the length of their employment. On the other hand, people working on semi-fixed jobs may also repeat their visit to certain places, but their initial visit to the place may have begun recently. For example, construction workers may work on a building site every weekday for several months, and then move to a different site, or a real-estate agent may regularly visit specific houses until they are sold. One possible repeat pattern can be that the place being visited may change sequentially, or the place may be visited repeatedly for a few months and be visited rarely afterwards.

In one embodiment, the system can infer employment based on the distance of travel from the user's home. Although people may travel a long distance, such as tens of miles, for employment purpose, they often tend to choose a closer location for consumer reasons, especially for day-to-day consumption activities, such as buying groceries or gas. For example, in FIG. 3, gas station 310 is about an hour away from user 300's home 304. Given the condition that the gas price at locations closer to user 300's home is roughly equal to that of gas station 310, the system can determine that user 300 is most likely going to gas station 310 for employment purposes. Similarly, the employment-inference system can also determine that user 300 goes to grocery store 306 for employment purposes, because the system detects the existence of several similar grocery stores much closer to user 300's home 304 than store 306.

In one embodiment, the system can use census data to infer employment. Census data can provide hints that indicate how likely a person is to be employed in a particular job based on his demographic information such as age group. For example, it is unlikely for a senior (age 65 and older) to be employed in a restaurant. Thus, when such a person is located in a restaurant, most likely he is eating there. To avoid error, an inference of a rare job may be subjected to additional scrutiny.

Contextual data collected from individuals whose jobs are known can be used to improve the accuracy of job inference for other individuals. In one embodiment, the system stores such data in a database, such as database 236 on remote server 230. In an alternative embodiment, the database resides on the mobile device. The system can compare contextual information extracted from a mobile device associated with a user to information stored in the database and determine whether the user is engaged in an employment-related activity. Examples of contextual data include, but are not limited to: the user's motion pattern, settings of mobile device, and ambient sound and light sensed by the mobile device.

Note that in a retail or restaurant establishment, the motion pattern of an employee can be very different from a customer. For example, a customer of a grocery store tends to have a motion pattern of walking with occasional pauses, whereas the motion pattern of a cashier can include standing for a long period of time. In a restaurant, the motion pattern of a customer may include sitting for a long period of time (while eating), whereas the motion pattern of a waiter may include constant walking. Although there may not be a clear behavior pattern for employees (because employees in one establishment may perform different functions and have different behavior patterns), customers of certain establishments tend to behave similarly. Therefore, if the system determines that a user's behavior pattern does not fit a customer model well, the system can determine that the user is engaged in an employment-related activity. Note that the known customer behavior pattern for certain establishments can be stored in a database.

The settings of a mobile device may also be different depending on whether the user is a customer or an employee. For example, employees with customer-facing jobs, such as cashiers in a department store, are more likely to switch off the ringer of their mobile phones during their work shift. In addition, employees of an establishment are more likely to charge their mobile devices than customers, who either do not have access to a charger or do not stay long. However, some locations, such as airports or coffee shops, do allow non-employees to charge their devices.

In addition, because in some establishments, surroundings of customers and employees can be different, the light and sound sensed by the corresponding mobiles devices may exhibit different characteristics. For example, the surroundings of customers of a fine dining place are often characterized by dim lights and soft sounds. In contrast, employees working in the same fine dining place may be exposed to the bright lights and loud noise of the kitchen. As a result, the light/sound sensed by a mobile device carried by a customer can be significantly different from that of an employee. Similarly, the light/sound characteristics experienced by a moviegoer, who spends most time in the dark theater can be very much different than those experienced by an employee of the theater, who spends most time in the bright lobby. Note that the ambient light/sound characteristics detected by users with known employment can also be stored in the database.

In one embodiment, the system infers employment based on whether the user is using the mobile device for employment-related activity. For example, the system can extract information from a calendar installed on the mobile device. Such a calendar may suggest a time that employment-related activity occurs. Or, the system can detect the user's correspondence, such as emails or phone calls, with known work colleagues. Such correspondence often indicates employment-related activity as well.

Other information that can be collected by sensors on a mobile device includes, but is not limited to: the way a mobile phone is carried, the sound of an alarm clock, or the detection of a second mobile device. Because individuals employed in certain jobs may be more likely to carry their mobile phones in a specific way, the detection of the way that the mobile phone is carried can help infer employment. For example, uniform-wearing employees, such as police officers, may be more likely to carry their mobile phones in a particular pocket. Note that the way that a mobile phone is carried can be detectable from the accelerometer's motion trace or from its measurement of an angle. The microphone of a mobile phone may detect the sound of a user's alarm clock. In some cases, the alarm clock is located on the mobile device. If the alarm clock is set to an unusual time, such a time may indicate the beginning of a work shift. Some people may carry an employment-related mobile device, such as a work phone, only while at work. Therefore, if the user's personal mobile phone detects the presence of the work phone (either a phone known to be work related, or by strong correlation during certain times of the day), the system can determine that the user is involved with employment-related activity. Note that a mobile device can detect the presence of a second mobile device using a peer-to-peer communication technique such as Bluetooth® (registered trademark of Bluetooth Special Interest Group of Bellevue, Wash.) and/or infrared communication.

In a further embodiment, the system relies on the user to state the nature of their jobs explicitly to an electronic system, such as an online employment-registration system. Such an approach may run into problems when the user changes jobs, or the user may find it difficult to accurately determine a code used by the system that describes the nature of a job. Alternatively, the user might give partial information regarding their jobs, such as an indication that they are working at a particular time. Such partial information can be used to assist a more general job inference strategy. In addition, because people tend to work similar types of jobs, the knowledge of past employment can also be useful in inferring current employment.

To infer employment, some embodiments may require an observation of a user's behavior, such as repeated visits to a location, over a long period of time. In some embodiments, the system may be able to detect employment based on the user's one-time behavior, such as a long period of stay at a fixed location. Ideally, when a user switches jobs, the system adopts a solution that can quickly infer the new employment.

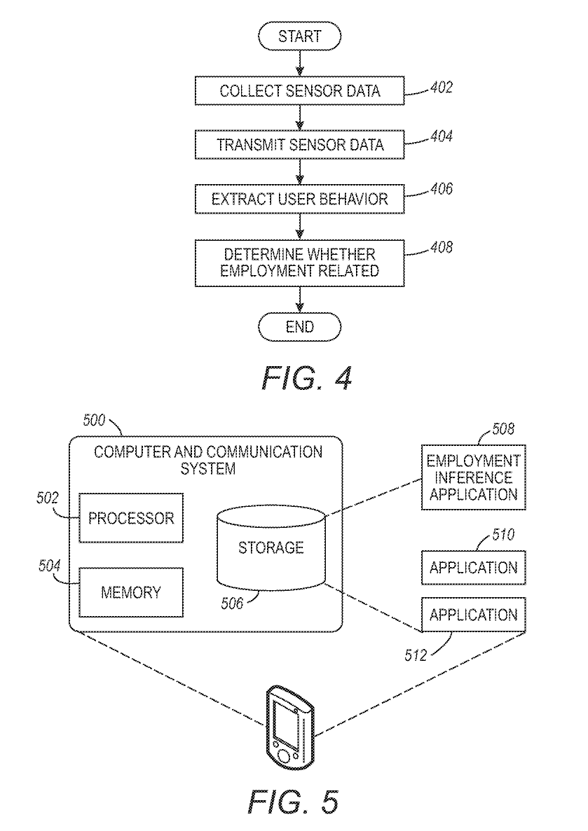

FIG. 4 presents a flowchart illustrating the process of determining employment-related activity based on an embodiment of the present invention. During operation, the system first collects sensor data from a mobile device associated with a user (operation 402). This sensor data includes, but is not limited to: GPS coordinates, current time, accelerometer traces, ambient lighting, and ambient sound (operation 402). The system may collect sensor data periodically over a long period of time, or the system may collect sensor data each time it receives a request for employment inference. The mobile device optionally transmits collected sensor data to a remote server (operation 404). In one embodiment, the sensor data computation and analysis are performed by the mobile device itself instead of by a remote server. Based on the collected sensor data, the system extracts the user's behavior pattern (operation 406). The system then determines whether the user is engaged in an employment-related activity (operation 408).

FIG. 5 illustrates an exemplary computer system for inferring employment in accordance with one embodiment of the present invention. In one embodiment, a computer and communication system 500 includes a processor 502, a memory 504, and a storage device 506. Storage device 506 stores an employment-inference application 508, as well as other applications, such as applications 510 and 512. In one embodiment, employment-inference application 508 further includes a program that facilitates the inference of employment using one or more of the aforementioned methods. During operation, employment-inference application 508 is loaded from storage device 506 into memory 504 and then executed by processor 502. While executing the program, processor 502 performs the aforementioned functions.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-executable method for inferring a user's activity, the method comprising:
collecting contextual information recorded by one or more components located on a mobile device associated with the user;
extracting the user's behavior pattern based on the collected contextual information; and
determining whether the user is engaged in an employment-related activity based at least on the user's behavior pattern.

2. The method of claim 1, wherein determining whether the user is engaged in employment-related activity comprises performing one or more of the following operations:
comparing the user's behavior pattern with a known user behavior pattern;
receiving the user's input of information associated with his employment; and
obtaining census data associated with employment.

3. The method of claim 1, wherein extracting the user behavior pattern involves:
extracting information associated with a location the user has visited; and
extracting timing information associated with the user corresponding to the location.

4. The method of claim 3, wherein the timing information comprises one or more of:
duration of the visit;
time of the day and/or time of the week of the visit;
repeat pattern of the visit; and
beginning and/or ending time of the visit.

5. The method of claim 3, wherein the location information comprises at least one of:
a venue type;
whether the location is a known location associated with the user's employment; and
distance from the location to the user's home.

6. The method of claim 1, wherein the components comprise at least one of:
a GPS receiver;
a WiFi receiver;
a Bluetooth® transceiver;
an accelerometer;
a clock;
a microphone;
a light sensor; and
a calendar.

7. The method of claim 6, further comprising one or more of:
extracting ambient sound information detected by the microphone;
extracting ambient light information detected by the light sensor;
extracting accelerometer traces;
extracting information regarding the setting of the mobile device; and
detecting presence of a second mobile device.

8. A system for inferring a user's activity, comprising:
a mobile device associated with the user for collecting contextual information, the mobile device comprising one or more components configured to collect contextual information;
an extraction mechanism configured to extract the user's behavior pattern based on the collected contextual information; and
a determination mechanism configured to determine whether the user is engaged in an employment-related activity based at least on the user's behavior pattern.

9. The system of claim 8, wherein the determination mechanism comprises one or more of:
a comparison mechanism configured to compare the user's behavior pattern with a known user behavior pattern;
a receiving mechanism configured to receive an input from the user of information associated with his employment; and
a mechanism configured to obtain census data associated with employment.

10. The system of claim 8, wherein the extraction mechanism is configured to:
extract information associated with a location the user has visited; and
extract timing information associated with the user corresponding to the location.

11. The system of claim 10, wherein the timing information comprises one or more of:
duration of the visit;
time of the day and/or time of the week of the visit;
repeat pattern of the visit; and
beginning and/or ending time of the visit.

12. The system of claim 10, wherein the location information comprises at least one of:
a venue type;
whether the location is a known location associated with the user's employment; and
distance from the location to the user's home.

13. The system of claim 8, wherein the components comprise at least one of:
a GPS receiver;
a WiFi receiver
a Bluetooth® transceiver;
an accelerometer;
a clock;
a microphone;
a light sensor; and
a calendar.

14. The system of claim 13, wherein the extraction mechanism is further configured to perform at least one of the following operations:
extracting ambient sound information detected by the microphone;
extracting ambient light information detected by the light sensor;
extracting accelerometer traces;
extracting information regarding the setting of the mobile device; and
detecting presence of a second mobile device.

15. A server for facilitating inference of a user's activity, the server comprising:
a receiving mechanism configured to receive contextual information recorded by one or more components located on a mobile device associated with the user;
an extraction mechanism configured to extract a behavior pattern of the user based on the collected contextual information; and
a determination mechanism configured to determine whether the user is engaged in employment-related activity based at least on the user's behavior pattern.

16. The mobile device server of claim 15, wherein the determination mechanism comprises one or more of:
a comparison mechanism configured to compare the user's behavior pattern with a known user behavior pattern;
a receiving mechanism configured to receive an input from the user information associated with his employment; and
a mechanism configured to obtain census data associated with employment.

17. The mobile device server of claim 15, wherein the extraction mechanism is configured to:
extract information associated with a location the user has visited; and
extract timing information associated with the user corresponding to the location.

18. The mobile device server of claim 17, wherein the timing information comprises one or more of:
duration of the visit;
time of the day and/or time of the week of the visit;
repeat pattern of the visit; and
beginning and/or ending time of the visit.

19. The mobile device server of claim 17, wherein the location information comprises at least one of:
a venue type;
whether the location is a known location associated with the user's employment; and
distance from the location to the user's home.

20. The mobile device server of claim 15, wherein the components comprise at least one of:
a GPS receiver;
a WiFi receiver
a Bluetooth® transceiver;
an accelerometer;
a clock;
a microphone;
a light sensor; and
a calendar.

21. The mobile device server of claim 15, wherein the extraction mechanism is further configured to perform at least one of the following operations:
extracting ambient sound information detected by the microphone;
extracting ambient light information detected by the light sensor;
extracting accelerometer traces;
extracting information regarding the setting of the mobile device; and
detecting presence of a second mobile device.
